(19) United States
(12) Patent Application Publication
(10) Pub. No.: US 2026/0351775 A1
(43) Pub. Date: Nov. 5, 2026

(54) BATTERY DEVICE

(71) Applicant: SK ON CO., LTD., Seoul (KR)

(72) Inventors: Jin-Su HAN, Daejeon (KR); Ju-Yong PARK, Daejeon (KR); Min-Song KANG, Daejeon (KR); Ji-Woong KIM, Daejeon (KR); Byeong-Jun PAK, Daejeon (KR); Suk-Ho SHIN, Daejeon (KR)

(21) Appl. No.: 19/105,040

(22) PCT Filed: Jun. 29, 2023
(86) PCT No.: PCT/KR2023/009162

§ 371 Date: Feb. 20, 2025

(30) Foreign Application Priority Data
Nov. 2, 2022 (KR) 10-2022-0144676

(51) Int. Cl. H01M 50/291; H01M 50/209; H01M 50/242; H01M 50/264

(52) U.S. Cl. CPC H01M 50/291; H01M 50/209; H01M 50/242; H01M 50/264

(57) ABSTRACT

A battery device according to an embodiment of the present invention comprises: a case accommodating a plurality of cell stacks; and at least one partition wall dividing the inner space of the case into a plurality of accommodation spaces, wherein the partition wall may comprise: a main frame forming the overall exterior of the partition wall; at least one fastening part disposed in the main frame and into which a fastening member for fastening the case to an external structure is inserted; and an elastic support part provided to the main frame and, when the cell stacks expand, absorbing the expanded volume.

### TECHNICAL FIELD

The present disclosure relates to a battery device having ease in the manufacturing thereof.

### BACKGROUND ART

Recently, a high-power battery device using a non-aqueous electrolyte having high-energy density has been developed. For use in motor driving of a device requiring high power, e.g., an electric vehicle, etc., the high-power battery device has been implemented with high capacity by connecting a plurality of battery cells or devices in series or in parallel.

A conventional battery device includes at least one partition wall that divides an internal space into a plurality of accommodation spaces. The number or size of partition walls may increase when the size of the battery device increases.

Accordingly, there is a need for a battery device including a partition wall, which is easy to manufacture and in which manufacturing costs are minimized.

### SUMMARY OF INVENTION

### Technical Problem

An aspect of the present disclosure is to provide a battery device having ease in the manufacturing thereof and in which manufacturing costs are minimized.

### Solution to Problem

According to an aspect of the present disclosure, a battery device includes a case accommodating a plurality of cell stacks and at least one partition wall dividing an internal space of the case into a plurality of accommodation spaces, in which the partition wall includes a main frame forming an overall exterior of the partition wall, at least one fastening portion disposed on the main frame and into which a fastening member for fastening the case to an external structure is inserted, and an elastic support portion disposed on the main frame and absorbing an expanded volume when the cell stack expands.

In the current embodiment, the fastening portion may include a body in a cylindrical shape and a fastening hole penetrating an inner side of the body, and the fastening hole may include a first region in a lower portion thereof and a second region formed above the first region and having a diameter less than a diameter of the first region.

In the current embodiment, the partition wall may be formed using a die-casting method.

In the current embodiment, the battery device may further include a reinforcing rib disposed on at least a portion of both sides of the main frame.

In the current embodiment, the reinforcing rib may be formed to protrude from the main frame in a shape of a lattice.

In the current embodiment, the elastic support portion may be formed in a box shape with an open bottom and a hollow interior, and include a support surface in contact with the cell stack, the support surface being formed as a flat surface.

In the current embodiment, the elastic support portion may include at least one reinforcing rib arranged therein, and the reinforcing rib may be arranged in a vertical direction.

In the current embodiment, the main frame may be arranged along a center of the partition wall in a thickness direction of the partition wall and has a shape of a plate, and the reinforcing rib may be formed to protrude on both sides of the main frame.

In the current embodiment, the main frame may comprise two main frames spaced apart from each other by a specific distance, and the reinforcing rib may be disposed between the two main frames.

In the current embodiment, the battery device may further include a top plate covering a top of the internal space, in which the top plate includes a through-hole into which the fastening portion is inserted.

### Advantageous Effects of Invention

According to an aspect of the present disclosure, a partition wall is manufactured using a die-casting method and a fastening portion is provided inside the partition wall, such that it is not necessary to add a separate member for fastening the battery device to a vehicle to the battery device. Therefore, manufacturing costs may be reduced and a mass of the partition wall may be minimized. Moreover, the manufacturing cost may be reduced by reducing a manufacturing process, and yield management may be easy to achieve.

### BRIEF DESCRIPTION OF DRAWINGS

FIG. 1 is a perspective view schematically illustrating a battery device according to an embodiment of the present disclosure.

FIG. 2 is a partial exploded perspective view of FIG. 1.

FIG. 3 is a partial exploded perspective view of FIG. 2.

FIG. 4 is an enlarged view of a partition wall illustrated in FIG. 3.

FIGS. 5 and 6 are partially cutaway perspective views along I-I′ of FIG. 4.

FIG. 7 is a perspective view of a partition wall according to another embodiment of the present disclosure.

FIG. 8 is a partially cutaway perspective view along II-II′ of FIG. 7.

FIG. 9 is a perspective view of a partition wall according to another embodiment of the present disclosure.

FIG. 10 is a partially cutaway perspective view along III-III′ of FIG. 9.

### MODE FOR INVENTION

Hereinafter, embodiments of the present disclosure will be described in detail with reference to the accompanying drawings. In the accompanying drawings, some components are exaggerated, omitted, or schematically shown, and the size of each component does not entirely reflect the actual size thereof.

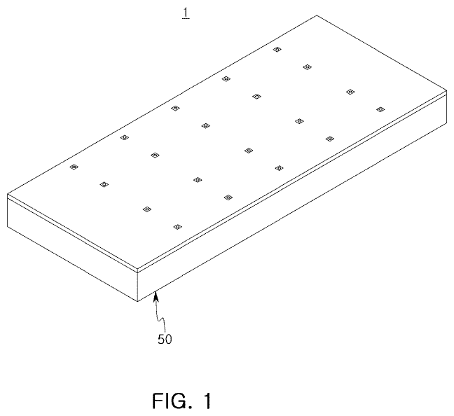

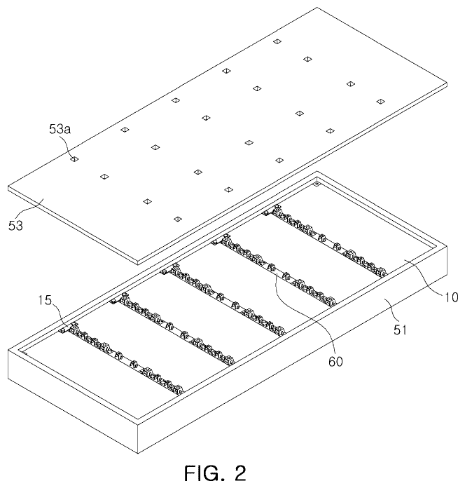

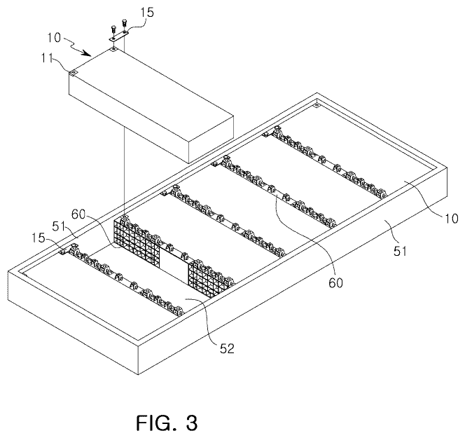

FIG. 1 is an exploded perspective view schematically illustrating a battery device according to an embodiment of the present disclosure, FIG. 2 is a partial exploded perspective view of FIG. 1, and FIG. 3 is a partial exploded perspective view of FIG. 2. Herein, FIG. 3 omits a top plate for convenience of a description.

Referring to FIGS. 1 to 3, a battery device 1 according to an embodiment of the present disclosure may include a plurality of cell stacks 10, a case 50, and a partition wall 60.

The cell stack 10 may include a secondary battery cell such as a lithium battery, a nickel metal hydride battery, etc., that is chargeable and dischargeable. Each cell stack 10 may be formed by stacking a plurality of battery cells in the shape of a hexahedron and a stacked state thereof may be fixed by being accommodated in a separate module case or by a bracket, etc.

The cell stack 10 may be provided with at least one terminal 11 on a side surface thereof. The terminal 11 may be a conductive member provided on a surface of the cell stack 10 to electrically connect the battery cells to the outside. The terminal 11 may include a positive terminal and a negative terminal, and the respective cell stacks may be electrically connected to each other through a bus bar 15 fastened to the terminal 11.

The case 50 may provide an accommodation space for accommodating other components therein. Thus, the case 50 may be provided to surround all of the cell stacks 10, and the plurality of cell stacks 10 may be arranged side by side, forming at least one column in the accommodation space of the case 50.

The case 50 may be formed of, but is not limited to, a metal material, to secure rigidity. To improve the effect of heat dissipation, at least a portion of the case 50 may be formed of aluminum.

The case 50 may include a sidewall part 51 forming an internal(inner) space, a bottom plate 52 covering a bottom of the internal space, and a top plate 53 covering a top of the internal space.

The sidewall part 51 may define the internal space while forming an outer surface of the case 50. Thus, the cell stacks 10 may be accommodated in the internal space defined by the sidewall part 51 and may be placed on the bottom plate 52.

The bottom plate 52 may support a bottom surface of the cell stacks 10 and at the same time, cool the cell stacks 10. The cell stacks 10 according to the current embodiment may be fastened to the bottom plate 52 or a partition wall 60 described below.

In the case 50 may be provided the partition wall 60 that is arranged across the internal(inner) space formed by the sidewall part 51 to divide the internal space into a plurality of accommodation spaces. Thus, at least a portion of the partition wall 60 may be fastened to the sidewall part 51.

The partition wall 60 may be coupled to the case 50 to reinforce the overall rigidity of the case 50. The partition wall 60 may also be disposed between the cell stacks 10 to suppress propagation of gas or flames between the cell stacks 10.

In the current embodiment, the partition wall 60 may be disposed between every two cell stacks 10 arranged side by side. The partition wall 60 may be fastened to the sidewall part 51 of the case 50 or with another partition wall 60, at opposite ends thereof, to divide the internal space formed by the sidewall part 51 into the plurality of accommodation spaces. The plurality of cell stacks 10 may be arranged in a distributed manner in the plurality of accommodation spaces divided by the sidewall part 51 and the partition wall 60.

The partition wall 60 may be welded to the case 50 or fixedly fastened to the case 50 through a fastening means such as a bolt, a screw, etc.

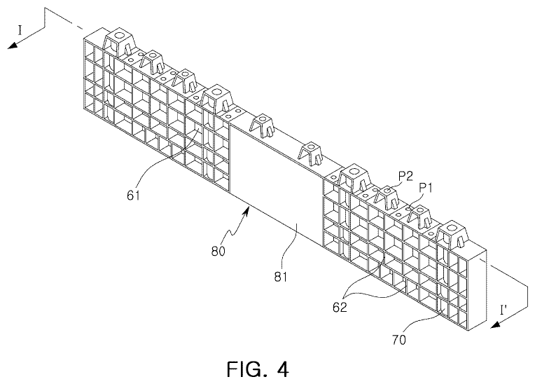

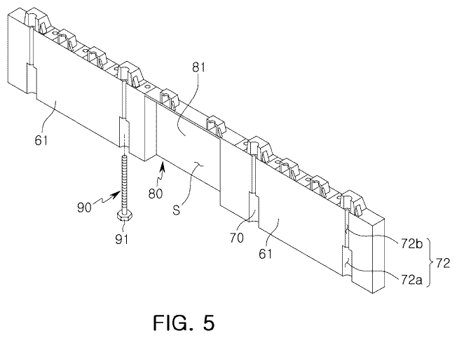

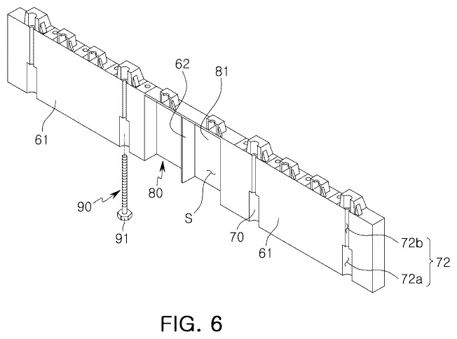

FIG. 4 is an enlarged view of a partition wall illustrated in FIG. 3, and FIGS. 5 and 6 are partially cutaway perspective views along I-I′ of FIG. 4.

Referring to FIGS. 4 to 6 together, the partition wall 60 according to the current embodiment may be manufactured using a die-casting method. In this case, when compared to manufacturing using an extrusion method, manufacturing costs may be reduced.

The partition wall 60 may be manufactured using aluminum, but various materials such as a resin compound, a composite material, etc., may be used as long as it is manufactured through an injection mold.

The partition wall 60 may be formed to have a uniform thickness as a whole, and may include a main frame 61, a reinforcing rib 62, a fastening portion 70, and an elastic support portion(part) 80.

The main frame 61 may be formed of a plate forming the overall exterior of the partition wall 60. In the current embodiment, the main frame 61 may be arranged along a center of the partition wall in a thickness direction of the partition wall 60. In this case, the main frame 61 may not be easy to arrange in a region where the fastening portion(part) 70 or the elastic support portion(part) 80 described below is arranged. Thus, the main frame 61 may be arranged in a region of the partition wall 60 other than the fastening portion 70 or the elastic support portion 80.

However, an embodiment of the present disclosure is not limited thereto, and the main frame 61 may be arranged to lean to a side rather than at a center of the partition wall 60 with respect to the thickness direction.

The reinforcing rib 62 may be formed on at least a portion of both sides of the partition wall 60. For example, the reinforcing rib 62 may be formed on the both sides of the main frame 61 or any one thereof. The reinforcing rib 62 may be formed not only on the main frame 61, but also outside the fastening portion 70 described below.

The reinforcing rib 62 may reinforce the rigidity of the partition wall 60. To this end, the reinforcing rib 62 according to the current embodiment may be formed to protrude from the main frame 61 in the shape of a lattice. However, a structure of the present disclosure is not limited thereto, and the reinforcing rib 62 may protrude from the main frame 61 in various shapes as long as it is capable of reinforcing the rigidity of the partition wall 60.

The fastening portion 70 may include a space into which a fastening member 90 is inserted.

The battery device 1 according to the current embodiment may be fixedly fastened to an external structure such as a vehicle, etc., by the fastening member 90. For example, the fastening member 90 may be coupled to a structure such as a frame of the vehicle while penetrating through the battery device 1, and to this end, the battery device 1 according to the current embodiment may include the fastening portion 70 inside the partition wall 60.

The fastening portion 70 may include a body in a cylindrical shape arranged long in a vertical direction of the partition wall 60, and a fastening hole 72 penetrating through the body in the vertical direction may be formed inside the body.

At least a portion of the fastening hole 72 may have a different diameter such that a bolt head 91 of the fastening member 90 supports the partition wall 60. For example, the fastening hole 72 may include a first region 72a having a greater diameter and a second region 72b having a diameter less than that of the first region 72a. The first region 72a may be formed to have the diameter allowing the bolt head 91 of the fastening member 90 to be inserted thereinto, and the second region 72b may be formed to have the diameter that does not allow the bolt head 91 to be inserted thereinto.

In the fastening portion 70 according to the current embodiment, the second region 72b may be disposed above the first region 72a. Thus, after the fastening member 90 is inserted into the first region 72a of the fastening hole 72 from a bottom of the battery device 1, the fastening member 90 may be coupled to the structure of the vehicle while penetrating through the fastening hole 72.

A plurality of fastening portions 70 may be disposed spaced apart from each other, and the body of the fastening portion 70 may be connected to the main frame 61 described above. The reinforcing rib 62 may be formed on an outer surface of the fastening portion 70, but the structure of the present disclosure is not limited thereto.

As the fastening member 90 is coupled to the structure of the vehicle while penetrating through the fastening portion 70, at least a portion of the fastening portion 70 may be exposed to outside the top plate 53. To this end, the top plate 53 may include a plurality of through-holes 53a into which the fastening portion 70 is inserted.

In addition, a fastening hole P1 for fastening the cell stack 10 to the partition wall 60 may be provided on a top surface of the partition wall 60. Although not shown, the cell stack 10 may be disposed such that at least a portion thereof overlaps the fastening hole P1, and a bolt or a screw may be fastened to penetrate overlapping portions. In addition, a fastening hole P2 for fastening the top plate 53 to the partition wall 60 may be provided on the top surface of the partition wall 60. In this case, the top plate 53 may be placed on the fastening hole P2, and a bolt or a screw may be fastened to the fastening hole P2 through the top plate 53.

Although not shown, a fastening hole for fastening the partition wall 60 to the bottom plate 52 may be provided on a bottom surface of the partition wall 60. However, the structure of the present disclosure is not limited thereto, and such fastening holes may be changed variously depending on a need.

The elastic support portion 80 may elastically support the cell stack 10.

Swelling may occur in at least one of battery cells forming the cell stack 10 according to circumstances. In this case, as a volume of a battery cell increases, a volume of the cell stack 10 may also increase and a corresponding pressure may be applied to the partition wall 60.

Thus, the elastic support portion 80 may be disposed in a region on which a pressure applied from the cell stack 10 is concentrated. The pressure may be concentrated mainly on a center portion of a surface contacting the partition wall 60. Thus, the elastic support portion 80 according to the current embodiment may be disposed on a center portion of a region in which the partition wall 60 faces the cell stack 10.

The elastic support portion 80 may be formed in the shape of an open box having an open bottom surface, and a support surface 81 contacting the cell stack 10 may be formed as a flat surface. When the reinforcing rib 62 is formed outside the support surface 81, it may press the reinforcing rib 62 in expansion of the cell stack 10, such that the pressure may be concentrated locally on the cell stack 10 by the reinforcing rib 62, thus damaging the cell stack 10.

Thus, the elastic support portion 80 according to the current embodiment may have the support surface 81 formed as a flat surface. An area of the support surface 81 may be defined corresponding to an area of the cell stack 10. When the elastic support portion 80 is formed excessively large, the rigidity of the partition wall 60 may be degraded. On the other hand, when the elastic support portion 80 is formed excessively small, the pressure may be concentrated on the reinforcing rib 62 side rather than the support surface 81 due to expansion of the cell stack 10. Thus, the elastic support portion 80 according to the current embodiment may have the support surface 81 formed to a size that is at least ¼, but not more than ½ of a contact area between the cell stack 10 and the partition wall 60. However, the present disclosure is not limited thereto.

As illustrated in FIG. 5, an inner side of the elastic support portion 80 according to the current embodiment may be formed as an empty space S. Thus, when the pressure is applied to the support surface 81 side due to expansion of the cell stack 10, the support surface 81 may be elastically deformed to reduce the empty space S. Thus, the expanded volume of the cell stack 10 may be accommodated in the elastic support portion 80.

Meanwhile, as the inner side of the elastic support portion 80 is formed as the empty space S, the rigidity of the elastic support portion 80 may be weaker than that of the main frame 61 having the reinforcing rib 62 formed therein. Thus, as illustrated in FIG. 6, at least one reinforcing rib 62 may be disposed inside the elastic support portion 80. As described above, the partition wall 60 according to the current embodiment may be manufactured using a die-casting method, and thus the internal space of the elastic support portion may be formed using a slide core (or an insert core). In this case, a moving direction of the slide core has to be considered, such that when the elastic support portion 80 merely has an open bottom surface like in the current embodiment, the reinforcing rib 62 arranged inside the elastic support portion 80 may be arranged merely in the vertical direction.

The battery device 1 according to the current embodiment structured in this way has the fastening portion 70 inside the partition wall 60, such that a separate member for fastening the battery device 1 to the vehicle is not required. For example, when the partition wall 60 is manufactured using an extrusion method, it is necessary to manufacture a separate member capable of supporting the fastening member 90 and couple the separate member to the partition wall 60 so as to form the fastening portion 70. However, as the partition wall 60 according to the current embodiment is manufactured using a die-casting method, the separate member may be omitted. Therefore, manufacturing costs may be reduced and a mass of the partition wall 60 may be minimized. Moreover, as a manufacturing process for coupling the separate member to the partition wall 60 is omitted, the manufacturing cost may be reduced and yield management may be easy to achieve.

In addition, as the partition wall 60 according to the current embodiment includes the elastic support portion 80 considering swelling of the cell stack 10, an expanded volume in the partition wall 60 may be absorbed in spite of expansion of the cell stack 10. Thus, it is possible to prevent the exterior of the battery device 1 from being deformed due to swelling of the cell stack 10.

Meanwhile, the present disclosure is not limited to the above-described embodiment, and various modifications may be possible.

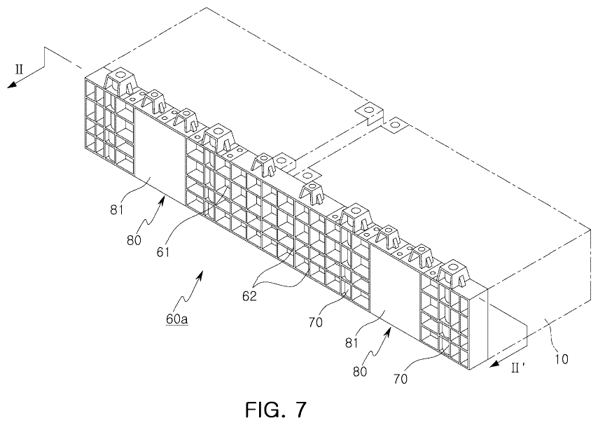

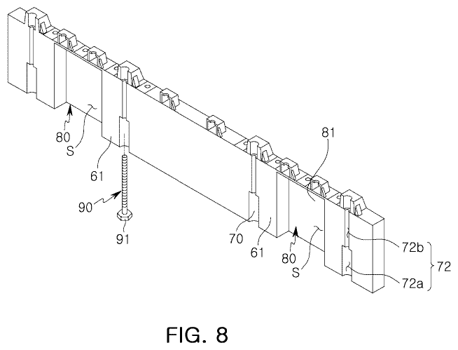

FIG. 7 is a perspective view of a partition wall according to another embodiment of the present disclosure, and FIG. 8 is a partially cutaway perspective view along II-II′ of FIG. 7.

Referring to FIGS. 7 and 8, a partition wall 60a according to the current embodiment may include two elastic support portions 80. The main frame 61 or the fastening portion 70 may be disposed between the two elastic support portions 80.

Such a structure may be made considering a case where the cell stacks 10 are arranged in two columns or battery cells are arranged in two columns inside the cell stack 10, as illustrated in FIG. 7. For example, each elastic support portion 80 may be arranged to correspond to each column of the cell stacks 10 arranged in two columns or each column of the battery cells arranged in two columns in the cell stack 10.

Thus, when the cell stacks 10 are arranged in three columns, the partition wall 60a according to the current embodiment may include three elastic support portions 80.

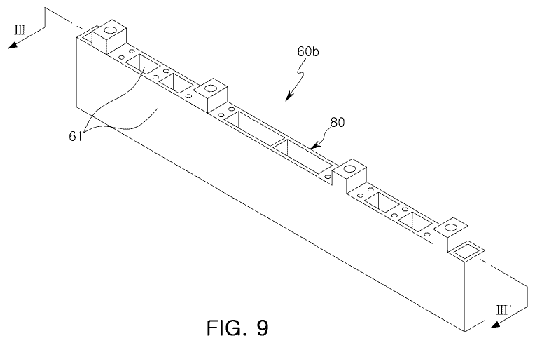

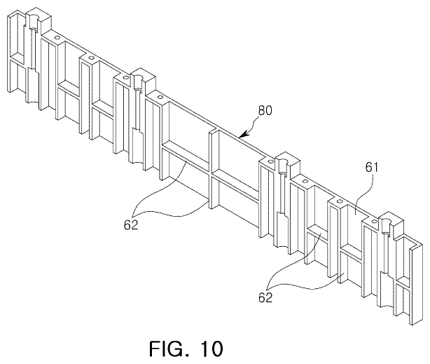

FIG. 9 is a perspective view of a partition wall according to another embodiment of the present disclosure, and FIG. 10 is a partially cutaway perspective view along III-III′ of FIG. 9.

Referring to FIGS. 9 and 10, in a partition wall 60b according to the current embodiment, the main frame 61 may comprise two main frames 61 spaced apart from each other by a specific distance and the reinforcing rib 62 may be disposed between two main frames 61.

When structured in this way, both sides of the partition wall 60 facing the cell stack 10 may be entirely formed as flat surfaces. Thus, the support surface of the elastic support portion 80 may be formed as a portion of the main frame 61.

The elastic support portion 80 according to the current embodiment may also have the top surface formed open as well as the open bottom surface. In this case, as the slide core may be disposed in both directions (a top surface side and a bottom surface side of the partition wall), the reinforcing rib 62 may be formed also in a longitudinal direction of the partition wall 60b inside the elastic support portion 80. However, a structure of the present disclosure is not limited thereto.

Although the embodiments of the present disclosure have been described in detail, the scope of the present disclosure is not limited thereto, and it would be obvious to those of ordinary skill in the art that various modifications and changes are possible without departing from the technical spirit of the present disclosure. In addition, embodiments may be carried out in combination.

1. A battery device comprising:
a case accommodating a plurality of cell stacks; and
at least one partition wall dividing an internal space of the case into a plurality of accommodation spaces,
wherein the partition wall comprises:
a main frame forming an overall exterior of the partition wall;
at least one fastening portion disposed on the main frame and into which a fastening member for fastening the case to an external structure is inserted; and
an elastic support portion disposed on the main frame and absorbing an expanded volume when the cell stack expands.

2. The battery device of claim 1, wherein the fastening portion comprises a body in a cylindrical shape and a fastening hole penetrating an inner side of the body,
and the fastening hole comprises a first region in a lower portion thereof and a second region formed above the first region and having a diameter less than a diameter of the first region.

3. The battery device of claim 2, wherein the partition wall is formed using a die-casting method.

4. The battery device of claim 1, further comprising a reinforcing rib disposed on at least a portion of both sides of the main frame.

5. The battery device of claim 4, wherein the reinforcing rib is formed to protrude from the main frame in a shape of a lattice.

6. The battery device of claim 1, wherein the elastic support portion is formed in a box shape with an open bottom and a hollow interior, and includes a support surface in contact with the cell stack, the support surface being formed as a flat surface.

7. The battery device of claim 6, wherein the elastic support portion comprises at least one reinforcing rib arranged therein, and
the reinforcing rib is arranged in a vertical direction.

8. The battery device of claim 4, wherein the main frame is arranged along a center of the partition wall in a thickness direction of the partition wall and has a shape of a plate, and the reinforcing rib is formed to protrude on both sides of the main frame.

9. The battery device of claim 1, wherein the main frame comprises two main frames spaced apart from each other by a specific distance, and the reinforcing rib is disposed between the two main frames.

10. The battery device of claim 1, further comprising a top plate covering a top of the internal space,
wherein the top plate comprises a through-hole into which the fastening portion is inserted.
